(19) United States
(12) Patent Application Publication
(10) Pub. No.: US 2023/0172184 A1
(43) Pub. Date: Jun. 8, 2023

(54) TRACEABILITY SYSTEM FOR PESTICIDE RESIDUES

(71) Applicant: Jiangsu Academy of Agricultural Sciences, Nanjing (CN)

(72) Inventors: Hongwu Bai, Nanjing (CN); Ying Liang, Nanjing (CN); Bing Gao, Nanjing (CN); Liping Bian, Nanjing (CN); Aidong Sun, Nanjing (CN); Xiaoming Sun, Nanjing (CN); Xianjin Liu, Nanjing (CN)

(21) Appl. No.: 17/681,854

(22) Filed: Feb. 28, 2022

(30) Foreign Application Priority Data
Dec. 3, 2021 (CN) 202111466203.6

(51) Int. Cl. A01M 7/00; A01B 79/00

(52) U.S. Cl. CPC A01M 7/0089; A01B 79/005

(57) ABSTRACT

The invention discloses a traceability system for pesticide residues, the main points of the technical scheme: the traceability system for pesticide residues, comprising the following steps; step 1, collecting the basic properties of a variety of pesticides commonly used in crops; step 2, collecting the degradation properties of pesticides in many different types of soils; step 3, collecting the rainfall, irrigation conditions and other agricultural operation factors; step 4, predicting the risk of pesticide residues on the surface of the soil after use, and speculating on the transfer pollution of pesticides to crops; step 5, predicting the pesticide residues available to leach into groundwater after pesticide use; step 6, predicting the pesticide residues available to leach into surface water after pesticide use. The traceability system for pesticide residues provides a set of practical pesticide residues risk assessment tools for agricultural producers, environmental protection and legislative agencies, agricultural production management departments.

### TECHNICAL FIELD

The invention relates to the field of agriculture, in particular to a traceability system for pesticide residues.

### BACKGROUND

Pesticides inject productivity into agricultural production and increase the yield of crops; but it also brings a lot of problems invisibly, especially pesticides have caused many adverse effects on the environment.

Currently, there is a lack of a set of practical pesticide residues risk assessment tools for agricultural producers, environmental protection and legislative agencies, and agricultural production management departments, it is impossible to assess the residues of commonly used pesticides in soil and the risk of pesticide residues available to leach into groundwater and surface water under specific regional environmental conditions, and it is impossible to guide the rational selection and use of pesticides.

### SUMMARY OF THE INVENTION

In view of the problems mentioned in the background, the object of the invention is to provide a traceability system for pesticide residues to solve the problems mentioned in the background.

The above-mentioned technical object of the invention is achieved through the following technical schemes:

The traceability system for pesticide residues, comprising the following steps;

step 1, collecting the basic properties of a variety of pesticides commonly used in crops;

step 2, collecting the degradation properties of pesticides in many different types of soils;

step 3, collecting the rainfall, irrigation conditions and other agricultural operation factors;

step 4, predicting the risk of pesticide residues on the surface of the soil after use, and speculating on the transfer pollution of pesticides to crops;

step 5, predicting the pesticide residues available to leach into groundwater after pesticide use;

step 6, predicting the pesticide residues available to leach into surface water after pesticide use.

Preferably, the types of pesticides in step 1 include but are not limited to the following types: Methamidophos, phorate, Dimethoate, omethoate, Carbofuran, Alachlor, 2,4-D acid, Ametryn, Butachlor, Terbacil, Dicamba salt, Clomazone, Hexazinone, Imazapyr acid, Imazaquin acid, Imazethapyr, Propoxur, Aldicarb, Fenamiphos, terbufos, Chlorpyrifos, Atrazine.

Preferably, the basic property information of the pesticides in step 1 include but are not limited to the following: maximum use amount, number of applications, adsorption coefficient in soil and half-life in soil.

Preferably, the calculation of the loading of the pesticide is performed in step 4, including the loading concentration calculation of the pesticide and the prediction of the original deposition in soil;

the loading concentration of the pesticide is calculated as the following formula (1):

Load(kgm⁻²)=f×d×a×p formula (1);

wherein, in the formula: f is the times of the pesticide use, d is the amount of the pesticide used (kgm⁻²), a is the effective ingredient content (%), and p is the percentage of the the area where the pesticide is applied to the soil;

the prediction of the original deposition in soil is as the following formula (2) and formula (3):

Fₛₒᵢₗ=(1−Fᵢₙₜ)*(1−Fₐᵢᵣ) formula (2);

wherein, in the formula: Fₛₒᵢₗ is the proportion (%) of the pesticide residues sorbed onto soil particles after trial use; Fᵢₙₜ is the pesticide residues sorbed onto the surface of the crop after trial use of the pesticide. Fₐᵢᵣ is the pesticide residues partitioned to gaseous phase after the pesticide application, and is the air release factor, which is related to the vapor pressure of pesticide;

$$Csoil = \frac{Fsoil ⋆ LOAD}{Deepth ⋆ RHOpest} ; \qquad formula ( 3 )$$

wherein, in the formula: Cₛₒᵢₗ is the concentration of pesticide residues in soil after pesticide use (kg/kgsoil), Deepth is the depth of the soil where the pesticide is deposited (0.05 m (spray) or 0.2 m (mixed soil)); RHOₚₑₛₜ is the density of the soil where the pesticide is applied (kg/m³).

Preferably, the prediction of pesticide residues available to leach into groundwater is performed in step 5, including the calculation of the coefficient of pesticide retention in the soil, the calculation of the pesticide retention time in the soil, and the calculation of the coefficient of pesticide degradation in the soil;

the coefficient of pesticide retention in the soil is calculated as the following formula (4):

$$RF = [ 1 + \frac{ρ ⋆ {f}_{o c} ⋆ {K}_{o c}}{{θ}_{F C}} ] ; \qquad formula ( 4 )$$

wherein, in the formula: RF refers to the coefficient of pesticide retention in the soil, ρ refers to the bulk density of soil (kgm⁻³), f_{oc} refers to the content of organic matter in soil (kgkg⁻¹), θ_{FC} refers to the water content of field soil (m³ m⁻³), K_{oc} refers to the adsorption constant of pesticides on organic matter in soil;

the pesticide retention time in the soil is calculated as the following formula (5), formula (6), formula (7) and formula (8):

$$T = \frac{D ⋆ {θ}_{F C} ⋆ RF}{q} ; \qquad formula ( 5 )$$

wherein, in the formula: T refers to the pesticide retention time in the soil, D refers to the height from the ground surface to the compliance surface, θ_{FC} refers to the water content of field soil (m³ m⁻³), q refers to recharge rate of groundwater (mm), q recharge rate of groundwater (mm) is planned to be predicted by osmotic factors of rainfall and irrigation water, and the prediction method is as follows:

q=q_{rainfall}+q_{irrigation} formula (6);

q_{rainfall}=P*α formula (7);

q_{irrigation}=I*β formula (8);

wherein, in the formula: q_{rainfall} and q_{irrigation} refer to the groundwater recharged by rainfall and irrigation respectively, P and I refer to water volume of actual rainfall and irrigation respectively, and α and β refer to rainfall infiltration recharge coefficient and irrigation infiltration recharge coefficient respectively;

the coefficient of pesticide degradation in the soil is calculated as the following formula (9):

$${AF}_{G W} = exp [ \frac{- 0.693 ⋆ D ⋆ {θ}_{F C} ⋆ RF}{q ⋆ {t}_{1 / 2}} ] = exp [ - t ⋆ \frac{( ln 2 )}{{t}_{1 / 2}} ] ; \qquad formula ( 9 )$$

wherein, in the formula: AF_{GW} refers to the coefficient of pesticide degradation during the retention time in soil seepage zone, t_{1/2} refers to the half-life of the pesticide degradation in soil (d), RF refers to the coefficient of pesticide retention in the soil, q refers to recharge rate of groundwater (mm).

Preferably, according to Juryet.al theory, the soil is divided into 3 different levels, namely surface soil, transitional soil and remaining area, the total number of OC and microorganisms in the surface soil is fixed, the transitional soil is an area where the total number index of OC and microorganisms decreases, the total number of OC and microorganisms in the remaining area remains unchanged; the total AF_{GW} of the soil is calculated separately for the above three different soil layers, the total AF_{GW} is the product of the calculated values of the three soil layers, wherein:

the AF value calculation of the surface soil (<0.1 m), AF_{SZ} is calculated according to formula (9), the content of organic matter in soil is the content of organic matter in surface soil, and t_{1/2} is the measured half-life of pesticide degradation.

The transitional soil (0.1 m-1.0 m), AF_{TZ} will be calculated and predicted tentatively based on the content of organic matter and t_{1/2} in the soil layer of 0.4 m in the formula (9), which are the formulas (10):

$$\frac{d {f}_{o c}}{d z} = exp ( - k ( z - 0.1 ) ) \frac{d k}{d z} = exp ( - k ( z - 0.1 ) ) ; \qquad formula ( 10 )$$

wherein, in the formula: z is the depth of the transitional soil; k is the degradation rate of the pesticide (k=ln2/t_{1/2}); k=2.98;

the remaining soil layer (1.0 m-D), when AF_{RZ} is calculated, the f_{oc} and (ln2/t_{1/2}) of the soil layer are both represented by 1/10 of the surface soil, and the calculation is still carried out by formula (9);

the total coefficient of the pesticide degradation in the seepage soil layer is calculated by the product of the coefficients of pesticide degradation in the above three soil layers, as formula (11):

AF_{GW}=AF_{SZ}*AF_{TZ}*AF_{RZ} formula (11).

Preferably, the following formula (11), formula (12), formula (13), and formula (14) are used to predict the pesticide residues in the surface soil in step 6:

Ct=C₀*exp^{-kt} formula (13);

wherein, in the formula: Cₜ is the concentration of pesticide residues in the soil at t time (kgkg⁻¹), C₀ is the initial concentration of pesticide residues in the soil (kgkg⁻¹), k is the degradation rate of the pesticide in surface soil (d⁻¹), and t is the evaluation time (d);

K=ln2/t_{1/2} formula (14);

wherein, in the formula: t_{1/2} is the half-life of pesticide degradation under the default temperature condition;

Since the degradation of the pesticide in the soil environment is affected by factors such as temperature, soil moisture, soil adsorption activity and pH, the value of k is predicted by the following formula (15).

K=K_{ref}*( [symbol] ₁₀)^{ΔT}*f₀ formula (15);

f₀=(RT/RT₀)^{0.718} formula (16);

wherein, in the formula: Kref is the degradation rate at the default temperature (20° C.) d⁻¹, Q₁₀ is a default parameter (2.2); ΔT is the temperature variable, that is, ambient temperature-default temperature, f₀ is the influence factor of ambient moisture, the default ambient temperature under the experimental conditions is 20° C., and the default moisture is 50% of the maximum water holding capacity of the soil.

In summary, the invention mainly has the following advantageous effects:

the traceability system for pesticide residues provides a set of practical pesticide residues risk assessment tools for agricultural producers, environmental protection and legislative agencies, and agricultural production management departments. Focus on assessing the residues of commonly used pesticides in soil and the risk of pesticide residues available to leach into groundwater and surface water under specific regional environmental conditions, and guide the rational selection and use of pesticides; the traceability system for pesticide residues can be realized: predicting the residual risk of pesticides on the surface of the soil after use, and speculating on the transfer pollution of pesticides to crops, predicting the pesticide residues available to leach into groundwater after pesticide use, predicting the pesticide residues available to leach into surface water after pesticide use.

### DESCRIPTION OF EMBODIMENTS

The following describes the technical schemes in the embodiments of the invention clearly and completely, obviously, the described embodiments are only a part of the embodiments of the invention, rather than all the embodiments. Based on the embodiments of the invention, all other embodiments obtained by those skilled in the art without creative work shall fall within the protection scope of the invention.

### Embodiment 1

The traceability system for pesticide residues, comprising the following steps;

step 1, collecting the basic properties of a variety of pesticides commonly used in crops;

step 2, collecting the degradation properties of pesticides in many different types of soils;

step 3, collecting the rainfall, irrigation conditions and other agricultural operation factors;

step 4, predicting the risk of pesticide residues on the surface of the soil after use, and speculating on the transfer pollution of pesticides to crops;

step 5, predicting the pesticide residues available to leach into groundwater after pesticide use;

step 6, predicting the pesticide residues available to leach into surface water after pesticide use.

The types of pesticides in step 1 include but are not limited to the following types: Methamidophos, phorate, Dimethoate, omethoate, Carbofuran, Alachlor, 2,4-D acid, Ametryn, Butachlor, Terbacil, Dicamba salt, Clomazone, Hexazinone, Imazapyr acid, Imazaquin acid, Imazethapyr, Propoxur, Aldicarb, Fenamiphos, terbufos, Chlorpyrifos, Atrazine, as shown in Table 1 and Table 2.

TABLE 1
Five pesticides used for model prediction

| | | | Adsorption | |
|---|---|---|---|---|
| | Maximum | | coefficient | Half-life |
| Name of | use amount | Number of | in soil | in soil |
| pesticide | (Lb ai/acre) | applications | (Koc) | (d) |
| Methamidophos | 60 | 4 | 0.1 | 2 |
| Phorate | 6 | 1 | 5240 | 8 |
| Dimethoate | 55 | 4 | 3.19 | 7 |
| Omethoate | 55 | 1 | 0.115 | 7 |
| Carbofuran | 5 | 1 | 22 | 0 |

TABLE 2
Pesticide varieties with potential risks to groundwater

| | | | Adsorption | |
|---|---|---|---|---|
| | | Maximum | coefficient | Half-life |
| Pesticide | | use amount | in soil | in soil |
| type | English name | (Lb ai/acre) | (Koc) | (d) |
| Herbicide | Alachlor | 4.00 | 170 | 15 |
| | 2,4-D acid | 1.78 | 20 | 10 |
| | Ametryn | 3.56 | 300 | 60 |
| | Butachlor | 4.01 | 700 | 12 |
| | Terbacil | 3.57 | 55 | 120 |
| | Dicamba salt | 0.26 | 1000 | 14 |
| | Clomazone | 0.51 | 300 | 24 |
| | Hexazinone | 10.7 | 54 | 90 |
| | Imazapyr acid | 1.51 | 100 | 90 |
| | Imazaquin acid | 0.12 | 20 | 60 |
| | Imazethapyr | 0.09 | 10 | 90 |
| | Propoxur | 0.17 | 30 | 30 |
| Pesticide | Aldicarb | 1.61 | 30 | 30 |
| | Fenamiphos | 6.69 | 100 | 50 |
| | terbufos | 2.23 | 371 | 18 |
| | Chlorpyrifos | 0.67 | 6070 | 30 |
| | Atrazine | 1.67 | 100 | 60 |

The basic property information of the pesticides in step 1 include but are not limited to the following: maximum use amount, number of applications, adsorption coefficient in soil and half-life in soil.

The calculation of the loading of the pesticide is performed in step 4, including the loading concentration calculation of the pesticide and the prediction of the original deposition in soil;

the loading concentration of the pesticide is calculated as the following formula (1):

Load(kgm⁻²)=f×d×a×p formula (1);

wherein, in the formula: f is the times of the pesticide use, d is the amount of the pesticide used (kgm⁻²), a is the effective ingredient content (%), and p is the percentage of the the area where the pesticide is applied to the soil;

the prediction of the original deposition in soil is calculated as the following formula (2) and formula (3):

Fₛₒᵢₗ=(1−Fᵢₙₜ)*(1−Fₐᵢᵣ) formula (2);

wherein, in the formula: Fₛₒᵢₗ is the proportion (%) of the pesticide residues sorbed onto soil particles after trial use; Fᵢₙₜ is the pesticide residues sorbed onto the surface of the crop after trial use of the pesticide. Fₐᵢᵣ is the pesticide residues partitioned to gaseous phase after the pesticide application, and is the air release factor, which is related to the vapor pressure of pesticide, as shown in Table 3;

TABLE 3
Air release factors of pesticides with different vapor pressures

| Pesticide Vapor | |
|---|---|
| Pressure/10⁻³ Pa | Air Release Factor |
| greater than 10 | 0.4 |
| 1-10 | 0.32 |
| 0.1-1 | 0.15 |
| 0.01-0.1 | 0.08 |
| less than or equal to 0.01 | 0.02 |

$$Csoil = \frac{Fsoil ⋆ LOAD}{Deepth ⋆ RHOpest} ; \qquad formula ( 3 )$$

wherein, in the formula: Cₛₒᵢₗ is the concentration of pesticide residues in soil after pesticide use (kg/kgsoil), Deepth is the depth of the soil where the pesticide is deposited (0.05 m (spray) or 0.2 m (mixed soil)); RHOₚₑₛₜ is the density of the soil where the pesticide is applied (kg/m³).

The prediction of pesticide residues available to leach into groundwater is performed in step 5, including the calculation of the coefficient of pesticide retention in the soil, the calculation of the pesticide retention time in the soil, and the calculation of the coefficient of pesticide degradation in the soil;

the coefficient of pesticide retention in the soil is calculated as the following formula (4):

$$RF = [ 1 + \frac{ρ ⋆ {f}_{o c} ⋆ {K}_{o c}}{{θ}_{F C}} ] ; \qquad formula ( 4 )$$

wherein, in the formula: RF refers to the coefficient of pesticide retention in the soil, ρ refers to the bulk density of soil (kgm⁻³), f_{oc} refers to the content of organic matter in soil (kgkg⁻¹), θ_{FC} refers to the water content of field soil (m³ m⁻³), K_{oc} refers to the adsorption constant of pesticides on organic matter in soil;

the pesticide retention time in the soil is calculated as the following formula (5), formula (6), formula (7) and formula (8):

$$T = \frac{D ⋆ {θ}_{F C} ⋆ RF}{q} ; \qquad formula ( 5 )$$

wherein, in the formula: T refers to the pesticide retention time in the soil, D refers to the height from the ground surface to the compliance surface, θ_{FC} refers to the water content of field soil (m³ m⁻³), q refers to recharge rate of groundwater (mm), q recharge rate of groundwater (mm) is planned to be predicted by osmotic factors of rainfall and irrigation water, and the prediction method is as follows:

q=q_{rainfall}+q_{irrigation} formula (6);

q_{rainfall}=P*α formula (7);

q_{irrigation}=I*β formula (8);

wherein, in the formula: q_{rainfall} and q_{irrigation} refer to the groundwater recharged by rainfall and irrigation respectively, P and I refer to water volume of actual rainfall and irrigation respectively, and α and β refer to rainfall infiltration recharge coefficient and irrigation infiltration recharge coefficient respectively, as shown in Table 4 and Table 5;

TABLE 4
Estimated table of annual rainfall infiltration recharge
coefficient α of soils with different properties

| Average | |
|---|---|
| annual | |
| rainfall | Soil properties |

| (mm) | clay | sandy clay | clayly sand | fine sand |
|---|---|---|---|---|
| 50 | 0-0.02 | 0.01-0.05 | 0.02-0.07 | 0.05-0.11 |
| 100 | 0.01-0.03 | 0.02-0.06 | 0.04-0.09 | 0.07-0.13 |
| 200 | 0.03-0.05 | 0.04-0.10 | 0.07-0.13 | 0.10-0.17 |
| 400 | 0.05-0.11 | 0.08-0.15 | 0.12-0.20 | 0.15-0.23 |
| 600 | 0.08-0.14 | 0.11-0.20 | 0.15-0.24 | 0.20-0.29 |
| 800 | 0.09-0.15 | 0.13-0.23 | 0.17-0.26 | 0.22-0.31 |
| 1000 | 0.08-0.15 | 0.14-0.23 | 0.18-0.26 | 0.22-0.31 |
| 1200 | 0.07-0.14 | 0.13-0.21 | 0.17-0.25 | 0.21-0.29 |
| 1500 | 0.06-0.12 | 0.11-0.18 | 0.15-0.22 | |
| 1800 | 0.05-0.10 | 0.09-0.15 | 0.13-0.19 | |

TABLE 5
Estimated table of annual irrigation infiltration recharge
coefficient β of soils with different properties

| groundwater | Irrigation | | | |
|---|---|---|---|---|
| depth | water volume | soil properties | | |
| (m) | (mm) | sandy clay | clayly sand | fine sand |
| <4 | 50-100 | 0.1 | 0.1 | |
| | 100-150 | 0.1 | 0.15 | 0.2 |
| | >150 | 0.1 | 0.2 | 0.2 |
| 4-8 | 50-100 | 0.05 | 0.05 | 0.05 |
| | 100-150 | 0.05 | 0.05 | 0.05 |
| | >150 | 0.1 | 0.1 | 0.1 |
| >8 | 50-100 | 0.05 | 0.05 | 0.05 |
| | 100-150 | 0.05 | 0.05 | 0.05 |
| | >150 | 0.05 | 0.05 | 0.05 |

the coefficient of pesticide degradation in the soil is calculated as as the following formula (9):

$${AF}_{G W} = exp [ \frac{- 0.693 ⋆ D ⋆ {θ}_{F C} ⋆ RF}{q ⋆ {t}_{1 / 2}} ] = exp [ - t ⋆ \frac{( ln 2 )}{{t}_{1 / 2}} ] ; \qquad formula ( 9 )$$

wherein, in the formula: AF_{GW} refers to the coefficient of pesticide degradation during the retention time in soil seepage zone, t_{1/2} refers to the half-life of the pesticide degradation in soil (d), RF refers to the coefficient of pesticide retention in the soil, q refers to recharge rate of groundwater (mm).

Wherein, according to Juryet.al theory, the soil is divided into 3 different levels, namely surface soil, transitional soil and remaining area, the total number of OC and microorganisms in the surface soil is fixed, the transitional soil is an area where the total number index of OC and microorganisms decreases, the total number of OC and microorganisms in the remaining area remains unchanged; the total AF_{GW} of the soil is calculated separately for the above three different soil layers, the total AF_{GW} is the product of the calculated values of the three soil layers, wherein:

the AF value calculation of the surface soil (<0.1 m), AF_{SZ} is calculated according to formula (9), the content of organic matter in soil is the content of organic matter in surface soil, and t_{1/2} is the measured half-life of pesticide degradation.

The transitional soil (0.1 m-1.0 m), AF_{TZ} will be calculated and predicted tentatively based on the content of organic matter and t_{1/2} in the soil layer of 0.4 m in the formula (9), which are the formulas (10):

$$\frac{d {f}_{o c}}{d z} = exp ( - k ( z - 0.1 ) ) \frac{d k}{d z} = exp ( - k ( z - 0.1 ) ) ; \qquad formula ( 10 )$$

wherein, in the formula: z is the depth of the transitional soil; k is the degradation rate of the pesticide (k=ln2/t_{1/2}); k=2.98;

the remaining soil layer (1.0 m-D), when AF_{RZ} is calculated, the f_{oc} and (ln2/t_{1/2}) of the soil layer are both represented by 1/10 of the surface soil, and the calculation is still carried out by formula (9);

The total coefficient of the pesticide degradation in the seepage soil layer is calculated by the product of the coefficients of pesticide degradation in the above three soil layers, as formula (11):

AF_{GW}=AF_{SZ}*AF_{TZ}*AF_{RZ} formula (11).

Preferably, the following formula (11), formula (12), formula (13), and formula (14) are used to predict the pesticide residues in the surface soil in step 6:

Ct=C₀*exp^{-kt} formula (13);

wherein, in the formula: Cₜ is the concentration of pesticide residues in the soil at t time (kgkg⁻¹), C₀ is the initial concentration of pesticide residues in the soil (kgkg⁻¹), k is the degradation rate of the pesticide in surface soil (d⁻¹), and t is the evaluation time (d);

K=ln2/t_{1/2} formula (14);

wherein, in the formula: t_{1/2} is the half-life of pesticide degradation under the default temperature condition;

Since the degradation of the pesticide in the soil environment is affected by factors such as temperature, soil moisture, soil adsorption activity and pH, the value of k is predicted by the following formula (15).

K=K_{ref}*( [symbol] ₁₀)^{ΔT}*f₀ formula (15);

f₀=(RT/RT₀)^{0.718} formula (16);

wherein, in the formula: Kref is the degradation rate at the default temperature (20° C.) d⁻¹, Q₁₀ is a default parameter (2.2); ΔT is the temperature variable, that is, ambient temperature-default temperature, f₀ is the influence factor of ambient moisture, the default ambient temperature under the experimental conditions is 20° C., and the default moisture is 50% of the maximum water holding capacity of the soil.

Wherein, the traceability system for pesticide residues provides a set of practical pesticide residues risk assessment tools for agricultural producers, environmental protection and legislative agencies, and agricultural production management departments. Focus on assessing the residues of commonly used pesticides in soil and the risk of pesticide residues available to leach into groundwater and surface water under specific regional environmental conditions, and guide the rational selection and use of pesticides; the traceability system for pesticide residues can be realized: predicting the residual risk of pesticides on the surface of the soil after use, and speculating on the transfer pollution of pesticides to crops, predicting the pesticide residues available to leach into groundwater after pesticide use, predicting the pesticide residues available to leach into surface water after pesticide use.

In this embodiment, the amount of pesticide residues is calculated according to the application method, application times, pesticides used and applied plants; based on the data collected, the pesticide residue index for each area is displayed on a map; professionals can customize the calculation model with “custom parameters” to make the calculation more accurate.

Although the embodiments of the invention have been shown and described, those skilled in the art can understand that various changes, modifications, substitutions and variations can be made to these embodiments without departing from the principle and spirit of the invention, the scope of the invention is limited by the attached claims and their equivalents.

1. The traceability system for pesticide residues, comprising the following steps;
step 1, collecting the basic properties of a variety of pesticides commonly used in crops;
step 2, collecting the degradation properties of pesticides in many different types of soils;
step 3, collecting the rainfall, irrigation conditions and other agricultural operation factors;
step 4, predicting the risk of pesticide residues on the surface of the soil after use, and speculating on the transfer pollution of pesticides to crops;
step 5, predicting the pesticide residues available to leach into groundwater after pesticide use;
step 6, predicting the pesticide residues available to leach into surface water after pesticide use.

2. A traceability system for pesticide residues according to claim 1, wherein the types of pesticides in step 1 include but are not limited to the following types: Methamidophos, phorate, Dimethoate, omethoate, Carbofuran, Alachlor, 2,4-D acid, Ametryn, Butachlor, Terbacil, Dicamba salt, Clomazone, Hexazinone, Imazapyr acid, Imazaquin acid, Imazethapyr, Propoxur, Aldicarb, Fenamiphos, terbufos, Chlorpyrifos, Atrazine.

3. A traceability system for pesticide residues according to claim 1, wherein the basic property information of the pesticides in step 1 include but are not limited to the following: maximum use amount, number of applications, adsorption coefficient in soil and half-life in soil.

4. A traceability system for pesticide residues according to claim 1, wherein the calculation of the loading of the pesticide is performed in step 4, including the loading concentration calculation of the pesticide and the prediction of the original deposition in soil;
the loading concentration of the pesticide is calculated as the following formula (1):
Load(kgm⁻²)=f×d×a×p formula (1);
wherein, in the formula: f is the times of the pesticide use, d is the amount of the pesticide used (kgm⁻²), a is the effective ingredient content (%), and p is the percentage of the the area where the pesticide is applied to the soil;
the prediction of the original deposition in soil is as the following formula (2) and formula (3):
Fₛₒᵢₗ=(1−Fᵢₙₜ)*(1−Fₐᵢᵣ) formula (2);
wherein, in the formula: Fₛₒᵢₗ is the proportion (%) of the pesticide residues sorbed onto soil particles after trial use; Fᵢₙₜ is the pesticide residues sorbed onto the surface of the crop after trial use of the pesticide. Fₐᵢᵣ is the pesticide residues partitioned to gaseous phase after the pesticide application, and is the air release factor, which is related to the vapor pressure of pesticide;
$$Csoil = \frac{Fsoil ⋆ LOAD}{Deepth ⋆ RHOpest} ; \qquad formula ( 3 )$$
wherein, in the formula: Cₛₒᵢₗ is the concentration of pesticide residues in soil after pesticide use (kg/kgsoil), Deepth is the depth of the soil where the pesticide is deposited (0.05 m (spray) or 0.2 m (mixed soil)); RHOₚₑₛₜ is the density of the soil where the pesticide is applied (kg/m³).

5. A traceability system for pesticide residues according to claim 1, wherein the prediction of pesticide residues available to leach into groundwater is performed in step 5, including the calculation of the coefficient of pesticide retention in the soil, the calculation of the pesticide retention time in the soil, and the calculation of the coefficient of pesticide degradation in the soil;
the coefficient of pesticide retention in the soil is calculated as the following formula (4):
$$RF = [ 1 + \frac{ρ ⋆ {f}_{o c} ⋆ {K}_{o c}}{{θ}_{F C}} ] ; \qquad formula ( 4 )$$
wherein, in the formula: RF refers to the coefficient of pesticide retention in the soil, ρ refers to the bulk density of soil (kgm⁻³), f_{oc} refers to the content of organic matter in soil (kgkg⁻¹), θ_{FC} refers to the water content of field soil (m³ m⁻³), K_{oc} refers to the adsorption constant of pesticides on organic matter in soil;
the pesticide retention time in the soil is calculated as the following formula (5), formula (6), formula (7) and formula (8):
$$T = \frac{D ⋆ {θ}_{F C} ⋆ RF}{q} ; \qquad formula ( 5 )$$
wherein, in the formula: T refers to the pesticide retention time in the soil, D refers to the height from the ground surface to the compliance surface, θ_{FC} refers to the water content of field soil (m³ m⁻³), q refers to recharge rate of groundwater (mm), q recharge rate of groundwater (mm) is planned to be predicted by osmotic factors of rainfall and irrigation water, and the prediction method is as follows:
q=q_{rainfall}+q_{irrigation} formula (6);
q_{rainfall}=P*α formula (7);
q_{irrigation}=I*β formula (8);
wherein, in the formula: q_{rainfall} and q_{irrigation} refer to the groundwater recharged by rainfall and irrigation respectively, P and I refer to water volume of actual rainfall and irrigation respectively, and α and β refer to rainfall infiltration recharge coefficient and irrigation infiltration recharge coefficient respectively;
the coefficient of pesticide degradation in the soil is calculated as the following formula (9):
$${AF}_{G W} = exp [ \frac{- 0.693 ⋆ D ⋆ {θ}_{F C} ⋆ RF}{q ⋆ {t}_{1 / 2}} ] = exp [ - t ⋆ \frac{( ln 2 )}{{t}_{1 / 2}} ] ; \qquad formula ( 9 )$$
wherein, in the formula: AF_{GW} refers to the coefficient of pesticide degradation during the retention time in soil seepage zone, t_{1/2} refers to the half-life of the pesticide degradation in soil (d), RF refers to the coefficient of pesticide retention in the soil, q refers to recharge rate of groundwater (mm).

6. A traceability system for pesticide residues according to claim 5, wherein according to Juryet.al theory, the soil is divided into 3 different levels, namely surface soil, transitional soil and remaining area, the total number of OC and microorganisms in the surface soil is fixed, the transitional soil is an area where the total number index of OC and microorganisms decreases, the total number of OC and microorganisms in the remaining area remains unchanged; the total AF_{GW} of the soil is calculated separately for the above three different soil layers, the total AF_{GW} is the product of the calculated values of the three soil layers, wherein:
the AF value calculation of the surface soil (<0.1 m), AF_{SZ} is calculated according to formula (9), the content of organic matter in soil is the content of organic matter in surface soil, and t_{1/2} is the measured half-life of pesticide degradation.
The transitional soil (0.1 m-1.0 m), AF_{TZ} will be calculated and predicted tentatively based on the content of organic matter and t_{1/2} in the soil layer of 0.4 m in the formula (9), which are the formulas (10):
$$\frac{d {f}_{o c}}{d z} = exp ( - k ( z - 0.1 ) ) \frac{d k}{d z} = exp ( - k ( z - 0.1 ) ) ; \qquad formula ( 10 )$$
wherein, in the formula: z is the depth of the transitional soil; k is the degradation rate of the pesticide (k=ln2/t_{1/2}); k=2.98;
the remaining soil layer (1.0 m-D), when AF_{RZ} is calculated, the f_{oc} and (ln2/t_{1/2}) of the soil layer are both represented by 1/10 of the surface soil, and the calculation is still carried out by formula (9);
the total coefficient of the pesticide degradation in the seepage soil layer is calculated by the product of the coefficients of pesticide degradation in the above three soil layers, as formula (11):
AF_{GW}=AF_{SZ}*AF_{TZ}*AF_{RZ} formula (11).

7. A traceability system for pesticide residues according to claim 1, wherein the following formula (11), formula (12), formula (13), and formula (14) are used to predict the pesticide residues in the surface soil in step 6:
Ct=C₀*exp^{-kt} formula (13);
wherein, in the formula: Cₜ is the concentration of pesticide residues in the soil at t time (kgkg⁻¹), C₀ is the initial concentration of pesticide residues in the soil (kgkg⁻¹), k is the degradation rate of the pesticide in the surface soil (d⁻¹), and t is the evaluation time (d);
K=ln2/t_{1/2} formula (14);
wherein, in the formula: t_{1/2} is the half-life of pesticide degradation under the default temperature condition;
Since the degradation of the pesticide in the soil is affected by factors such as temperature, soil moisture, soil adsorption activity and pH, the value of k is predicted by the following formula (15).
K=K_{ref}*( [symbol] ₁₀)^{ΔT}*f₀ formula (15);
f₀=(RT/RT₀)^{0.718} formula (16);
wherein, in the formula: Kref is the degradation rate at the default temperature (20° C.) d⁻¹, Q₁₀ is a default parameter (2.2); ΔT is the temperature variable, that is, ambient temperature-default temperature, f₀ is the influence factor of ambient moisture, the default ambient temperature under the experimental conditions is 20° C., and the default moisture is 50% of the maximum water holding capacity of the soil.
